(19) United States
(12) Patent Application Publication
(10) Pub. No.: US 2008/0288728 A1
(43) Pub. Date: Nov. 20, 2008

(54) MULTICORE WIRELESS AND MEDIA SIGNAL PROCESSOR (MSP)

(76) Inventors: Aamir A. Farooqui, Sunnyvale, CA (US); Saima A. Farooqui, Sunnyvale, CA (US); Rajeev Huralikoppi, Sunnyvale, CA (US)

Correspondence Address: HAHN AND MOODLEY, LLP, P.O. BOX 52050, MINNEAPOLIS, MN, 55402, US

(21) Appl. No.: 12/122,900

(22) Filed: May 19, 2008

Related U.S. Application Data
(60) Provisional application No. 60/938,986, filed on May 18, 2007.

(51) Int. Cl. G06F 15/76; G06F 9/30; G06F 12/00

(52) U.S. Cl. 711/149; 712/1; 712/E09.016; 711/E12.001

(57) ABSTRACT

A media signal processor (MSP) architecture is disclosed in this invention To address the shortcomings of conventional high performance processing units, the MSP architecture is designed using a new concept in parallel processing—“Same Instruction Different Operation” (SIDO) and “Same Instruction Multiple Data” (SIMD) architectures. The scalable nature of the architecture makes it possible to add multiple cores to match the processing needs of any type of data processing application. With multiple MSPs working in parallel, multiple data streams can be processed in either parallel or in a sequentially pipelined manner, using a software-based control mechanism.

This application claims the benefit of priority to U.S. Provisional Patent Application No. 60/938,986 filed on May 18, 2007 and entitled “A MULTICORE WIRELESS AND MEDIA SIGNAL PROCESSOR (MSP)” which is hereby incorporated by reference.

### FIELD

The present invention relates to the field of architecture, design and development of micro processors used for video processing, image processing, wireless signal processing, speech recognition and matrix processing.

### BACKGROUND

Today's video and wireless applications are very complex and requires very high processing power. Several attempts have been made to counter these issues and to develop the high-speed architectures. One example is the Sony, IBM, and Toshiba Cell Processor.

Each Cell is composed of nine processing elements and runs at 3.2 GHz. The nine PE consist of one PowerPC core (Power Processing Element, PPE), and eight SIMD cores (Synergistic Processing Element SPE). The processing cores. Each SPE (Synergistic Processing Element) includes one MFC (memory flow controller), and one SPU (Synergistic Processig Unit). Each SPU includes a 256 KB local store (a memory disjoint from the DRAM address space), two in order SIMD datapaths, and a 128×128 b register file. Each SPU has its own program counter, and can only fetch instructions from its local store. It may issue up to two SIMD instructions per cycle if they are correctly packed into a 128 b quad word one is a integer, bitwise, or single precision floating point SIMD instruction the other is a load, store, permute, branch or channel instruction. The single precision SIMD datapaths are fully pipelined and can deliver up to 25.6 GFlop/s

All elements on the Cell chip are connected via the EIB (Element interconnect bus) which is composed of four 128 b rings running at 1.6 GHz. Two rings run in one direction, two run in the other. There are restrictions as to which ring data may be inserted into based on the source and destination of the data item. As such the latency and bandwidth is dependent on the communication pattern.

The Cell processor provides the compute power for many high-end applications, but architecture is very complex and requires very large hardware (Cell die size is about 220 mm̂2), and consumes very high power (few 100 Watts). This type of architecture is not suitable for low cost, low power applications.

### SUMMARY OF THE INVENTION

Media Signal Processor (MSP) is a high performance fixed-point processor composed of a programmable, single-clock-cycle-per-instruction processing engine. The MSP works in parallel and in conjunction with a host CPU. The host could be any general-purpose processor, such as ARM, MIPS, or PowerPC.

To address the shortcomings of conventional high performance processing units, the MSP architecture is designed using a new concept in parallel processing—“Same Instruction Different Operation” (SIDO) as is described in co-pending U.S. patent application Ser. No. 12/016,171 (which is hereby incorporated by reference) and “Same Instruction Multiple Data” (SIMD) architectures. The scalable nature of the architecture makes it possible to add multiple cores to match the processing needs of any type of video data processing application. With multiple MSPs working in parallel, multiple data streams can be processed in either parallel or in a sequentially pipelined manner, using a software-based control mechanism. In one embodiment of the present invention, the communication between cores is performed using shared memories without using expensive bus architectures or crossbar switches. A single MSP running at only 250 MHz, can achieve 10.5 Giga Operation per second.

The processor core works on the concept of ‘dataflow’, SIMD, and SIDO processing; therefore, it consumes much less power compared to other common solutions. Inherent low power consumption, a forte of the MSP architecture, is made possible through data-driven processing. The processor consumes power only when the data is available for processing else it stays in idle mode to conserve power. The adaptive nature of the architecture allows dynamic configuration of the program memory so that hardware can handle different types of applications, such as Video (MPEG-2, H.264, VM9 etc.), wireless (OFDM), or audio (MP3) etc. A single MSP based design is ideal for cell phones and other power sensitive applications because of its low power architecture. A multi-MSP based design can support a range of compute-intensive power applications, such as, real-time video processing of full High Definition TV resolution, at frame rate of 30 frames per second (f/s). The core processor can be efficiently programmed using highly optimized assembly code, referred to as ‘Tasks’, for multimedia and image-processing applications. This type of task based processing requires minimum intervention from host CPU. A single MSP running at only 250 MHz, can achieve 10.5 Giga Operation per second.

Additional advantages of the present invention will be set forth in the description which follows, and in part will be obvious from the description, or may be learned by practice of the invention. The advantages of the present invention may be realized and obtained by means of the instrumentalities and combinations particularly pointed out in the appended claims.

### BRIEF DESCRIPTION OF THE DRAWINGS

FIG. 1 is a high-level block diagram illustrating the main components of a processor and their interactions with each.

FIG. 2 illustrates the block diagram of the one embodiment of the present invention according to the present invention

FIG. 3 illustrates the Instruction execution on MSP.

FIG. 4 illustrates a typical data memory page layout.

FIG. 5 illustrates a typical instruction memory organization.

FIG. 6 describes the MSP control registers.

FIG. 7 illustrates the multi MSP sub system.

### DETAILED DESCRIPTION OF THE INVENTION

The present invention is best understood by referring to the accompanying figures and the detailed description set forth herein. Embodiments of the invention are discussed below with reference to the figures. However, those skilled in the art will readily appreciate that the description given herein with respect to the figures is for explanatory purposes as the invention extends beyond these limited embodiments.

Terminology: Given below is a list of definitions of the technical terms which are frequently used in this document:

SIDO: Same instruction different data

SIMD: Same instruction multiple data

PDP: Programmable Data-Path

MSP: Media Signal Processor

DAG: Data Address Generator

PCU: Program Control Unit

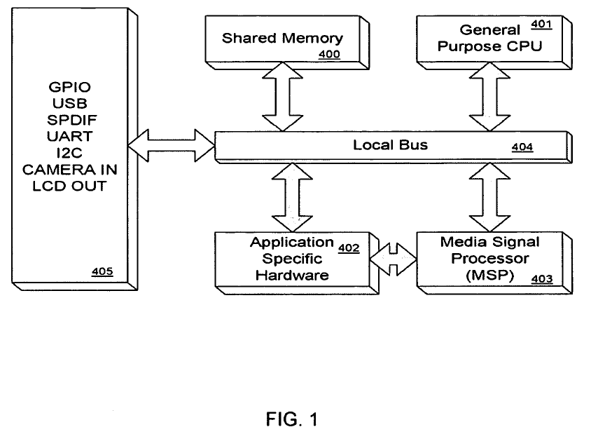

FIG. 1 illustrates the high-level block diagram of the sub-system based on Media Signal Processor (MSP) 403. An MSP subsystem requires a Host CPU 401 to load the program into the instruction memory of the MSP, and issue execution commands to it. MSP can communicate with CPU and the main memory 400 through internal DMA and standard bus 404. A hardware specific block for performing bit manipulation operations is also coupled with MSP to perform bit intensive operations.

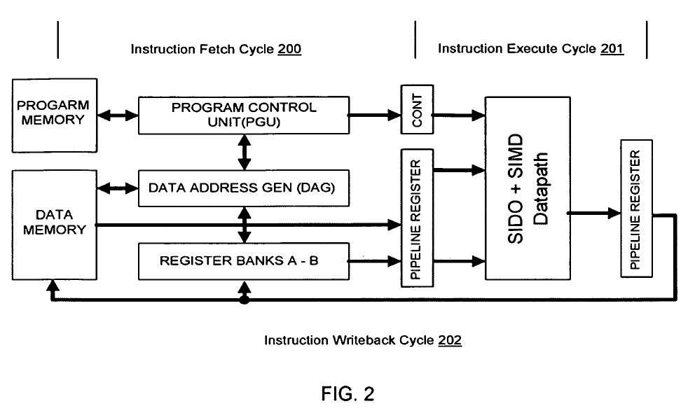

FIG. 2 illustrates the MSP Instruction execution cycles, each instruction is executed in three pipeline stages. During the first cycle 200, instruction is fetched, decoded and control signals are generated. During the second cycle 201 instruction is executed using PDP or PCU, and finally the result is written back in the third cycle 202.

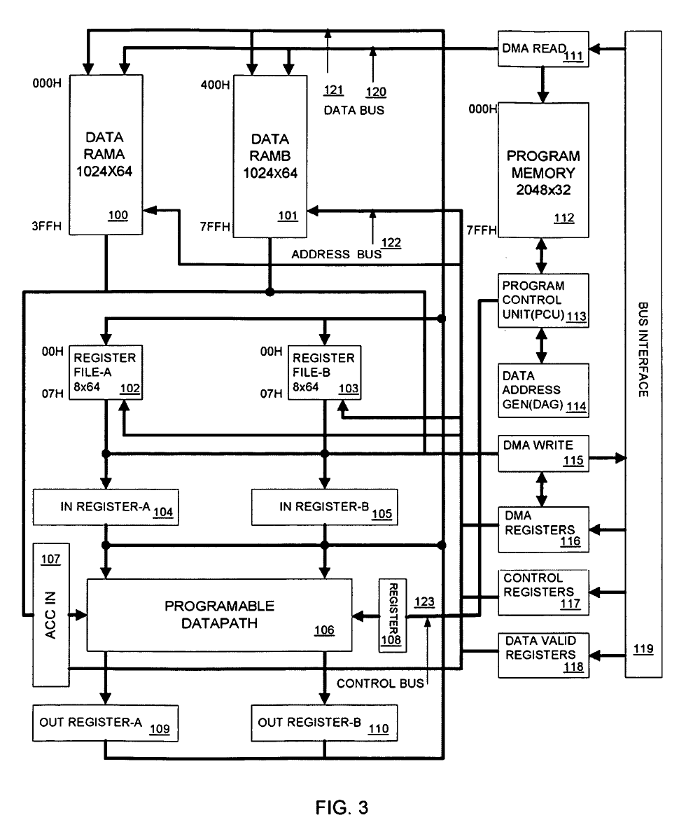

FIG. 3 illustrates an exemplary architecture of an MSP according to one preferred embodiment of the present invention.

A single Media Signal Processor (MSP) consists of the following main blocks:

1. Program Control Unit (PCU) 113

2. Instruction Memory 112

3. Data Memory 100-101

4. Same Instruction Different Operation (SIDO) and Single Instruction Multiple Data (SIMD) based Programmable Data Path (PDP) 106

5. Direct Memory Access (DMA) 111-115

6. Control Registers 117

7. Standard bus interface 119

A brief explanation of the purpose and working of each of these blocks is as follows:

1. Program Control Unit (PCU)

The Program Control Unit 103 (PCU) implements three-stage pipeline control of the MSP instruction execution. The PCU performs instruction fetch from the program memory 112, decodes the instruction, produces control signals 123, for the PDP 106, and performs data flow operations for inter core communication using data valid registers 118, and control register 117.

The PCU executes program flow instructions like CALL, RETURN, JUMP, Conditional JUMPS and hardware FOR loop control, without PDP 106 involvement. Each PCU controls different processing states of the MSP and consists of four hardware sub blocks:
Instruction Decode Unit (IDU): Decodes the 32-bit instruction loaded into the Instruction latch and generates all necessary pipeline control signals.
Data Address Generator 114 (DAG): Contains the hardware for data address generation using RAM, Registers, and Stack. The DAG calculates the effective address using the page offset addresses provided through the program memory at location 0-100 H. The DAG operates in parallel with the other core resources, and so minimizes address-generation overhead of instruction sequences.
Program Address Generator (PAG): Provides the hardware for program address generation. It is used in program and loop control instructions such as CALL, RTN, JUMP, Conditional JUMPS.
Data-valid control registers 118: These registers actually control the whole program execution.

Due to the data flow based architecture, the CALLs are executed only when the data-valid flags (in 32-bit datavalid register 118) corresponding to CALL instruction operands are set to ‘1’ (by the DMA or any other source). If the required valid bit is ‘0’ then the processor stays in the idle mode.

2. Instruction Memory Subsystem

The instruction memory functions as a buffer memory between the external memory and the core processor. When an application executes, the complete application instructions are copied into the instruction memory for direct access by the core processor. Since the same code is used frequently for different applications, the storage of these instructions in the local memory yields an increase in throughput, because external bus accesses are eliminated.

In the present embodiment, the MSP instruction memory 112, size is 2048×32 bits (2 K words) and it requires 11-bit address bus. The instruction memory resides in the memory space of the Host CPU i.e., it is memory mapped in the Host CPU. The first 128 locations of the instruction memory are reserved for program execution control and they are used for storing the CALL instructions for different tasks. These memory allocations can change during program execution. While, the rest of the instruction memory contains the actual subroutines, which are modified once at application

3. Data Memory Sub-System

In order to reduce external memory references, a total of 2K×64 bit internal memory is available for the PDP. The PDP memory is divided into two different logical memory spaces. Memory space 000-3FFH is referred as Data RAMA 100, and it is normally used for getting data from external memory or neighboring cores. Memory space 400-7FFH is referred as Data RAMB 101, and it is used for transferring data to external memory or neighboring cores. Both, these memory spaces can be read/written in a single clock cycle.

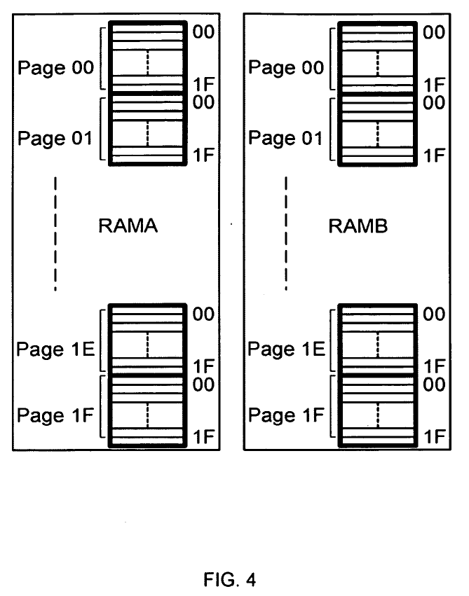

FIG. 4 illustrates the data memory layout. RAMA and RAMB memory is further divided into 32 pages of 32×64 bits each. Each page has an associated valid data bit in 32-bit validdata registers 118, for RAMA, and for RAMB respectively. Each bit in the validdata register corresponds to a page (bit#=page#) in the memory. The two validdata registers control the data flow during program execution through the CALL instruction. The CALL instruction is executed only when all the operands required by the subroutine (MSP task) are available and the corresponding valid bit is set. There are two banks of 8×64-bit registers, 104 and 105 for storing local variables and performing matrix transpose operation while writing data to the registers.

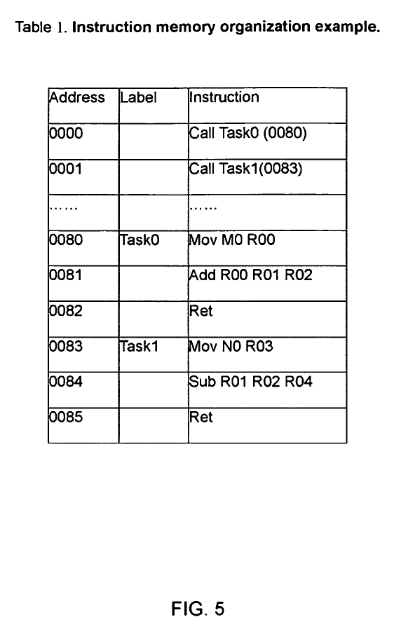

FIG. 5 illustrates the typical instruction memory organization, which contains a CALL to Task1, as the first instruction, and CALL to Task2 as the second instruction. Due to the data flow architecture the CALLs are executed only when the data-valid flags (in 32-bit datavalid register 118) corresponding to CALL instruction operands are set to ‘1’ (by the DMA or any other source). In other words if valid data is available in RAMA and RAMB, then CALL is executed. For example, CALL Task1, Page1, Page3, Page3 (CALL Task#, OP0 page#, OP1 page#, OUT page#) is executed only when OP0 (RAMA) Page1 valid bit and OP1 (RAMB) Page3 valid bits are set.

4. Programmable Data Path (PDP)

Programmable Data Path (PDP) 106 is the heart of the MSP core that performs all the complex mathematical computations. Its design is based on the most unique concept of parallel computing: Same Instruction Different Operation (SIDO) [patent reference] and Single Instruction Multiple Data (SIMD) It contains the hardware to execute proprietary instructions to perform multimedia operations at a very high speed. The PDP supports different types of SIMD Add, Subtract, Compare, Mean, Multiply, and Sum of product on 8, 16, and 32 bit signed/unsigned operands packed in 64-bits. In order to accelerate media processing new instructions have been developed. Using these proprietary instructions it is possible to perform a 4×4 H.264 Transform in just 12 clock cycles. All PDP instructions are executed in a single cycle, at a clock frequency of 250 MHz (90 nm). The PDP also supports a variety of Permute, Replicate, Unpack, and Shift operations and these operations can be combined with any arithmetic operations to perform complex operations, such as, Permute_Unpack_Mutiply_Accumulate_Shift in a single clock cycle. The PDP instructions are divided into the following groups:

ADD/SUB

MIN/MAX/COMPARE

MULTIPLY

SPECIAL

DATA FORMAT

The PDP can support integer additions and subtractions on signed and unsigned operands with or without permutation/replicate of the input operands and saturation of the result. Multiplication is one of the most important operations in multimedia signal processing. The PDP can support different kinds of multiply operations, including multiply with accumulate on signed and unsigned operands with or without permutation/replicate of the input operands and shift operation on the result

In order to accelerate media processing, new instructions are developed and these instructions are heavily used in video transformations and Motion Compensation. Details of this block are in a separate patent application.

5. Direct Memory Access (DMA)

The Direct Memory Access (DMA) block performs data transfers without the interaction of the core. It supports any combination of internal memory, internal peripheral I/O and external memory as source and destination for data transfer operations. The DMA block has multiple unidirectional DMA channels supporting internal and external accesses. A scatter/gather DMA operation is implemented through a linked list in the external memory under the control of the host CPU.

6. MSP Configuration Register

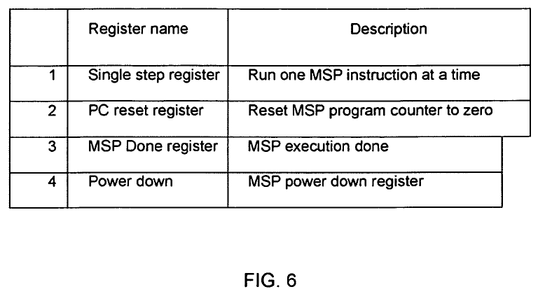

FIG. 6 illustrates the MSP configuration registers and their functions. There are four MSP configurations which control the program execution. The ‘single step register’ is used to debug the MSP and run one instruction per clock cycle. The ‘PC reset register’ resets the MSP program counter to zero. ‘MSP done register’ indicates the MSP execution is complete and the ‘MSP power down’ register is used to keep the MSP in idle state for power reduction.

Multi MSP Configuration

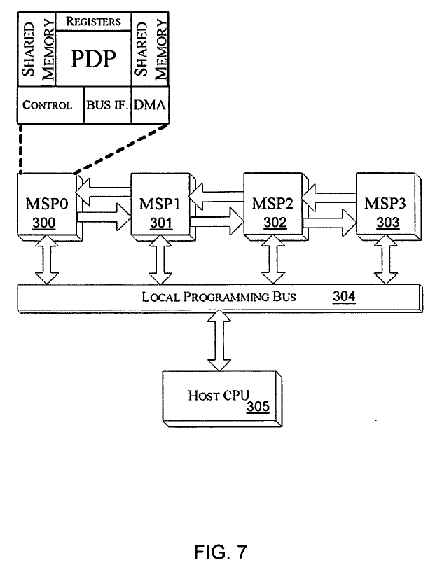

FIG. 7 illustrates the example of a Multi-MSP configuration in which four MSPs 300-303 are connected together using a local bus to a Host CPU. The inter processor communication is performed using dual ported shared memories without using expensive crossbar switches. In this configuration MSP0 300, writes to the RAMA of MSP1 301 in a single cycle, just like a normal memory write. Once all the data is written to MSP1, then validdata bit corresponding to memory location is set. This enables the execution of instructions depending on the data from MSP0.

1. A data processor comprising:
at least one memory for storing instructions,
at least one execution unit,
at least one memory for storing data,
at least one control unit for controlling the instruction execution of the processor, and
at least one control register to represent a valid data in data memory.
wherein the instruction execution is controlled by valid data bit in the control register.

2. The data processor of claim 1, further comprising a data memory with at least one memory for storing data with at least two write ports. The second write port enables the adjacent processors to write to the processor memories and control processor program execution by setting a bit in the valid data register.

3. The data processor of claim 1 and 2, further comprising a SIDO and SIMD execution units.
